(19) United States
(12) Patent Application Publication
(10) Pub. No.: US 2002/0081998 A1
(43) Pub. Date: Jun. 27, 2002

(54) Mobile information terminal apparatus with character mail transmission function

(75) Inventor: Kinya Tsuchiyama, Tokyo (JP)

Correspondence Address: Paul J. Esatto, Jr., Scully. Scott, Murphy & Presser, 400 Garden City Plaza, Garden City, NY, 11530, US

(73) Assignee: NEC Corporation, Tokyo (JP)

(21) Appl. No.: 10/023,126

(22) Filed: Dec. 18, 2001

(30) Foreign Application Priority Data
Dec. 26, 2000 (JP) 2000-394336

(51) Int. Cl. H04M 11/10

(52) U.S. Cl. 455/412; 455/517

(57) ABSTRACT

Mail generating means for generating character mail, transmission time setting means for setting transmission execution time of the generated character mail, and mail transmitting means for transmitting the character mail at the set time are comprised, and character mail generation time and character mail transmission execution time are separable, and character mail transmission can be executed at desired time.

### BACKGROUND OF THE INVENTION

The present invention relates to a mobile information terminal apparatus having a character mail transmission function, which comprises a function for arbitrarily setting transmission time of generated mail, in other words, capable of making a transmission reservation in which arbitrary time is specified.

A mobile information terminal apparatus having a character mail transmission function, which is represented by an i-mode and an EZweb, comes into wide use, and also, data communication content goes on increasing. In transmission of character mail in such a mobile information terminal, mail generation is conducted so as to match with desired transmission time, and after completion, the transmission is executed at a time point when a transmission operation is conducted.

However, there are not a few cases where a plan and an act of a user on a reception terminal side are understood, and further, where it is expected that, in accordance with a requirement of legal restriction or a regulation and so forth, “since transmission (reception) cannot be conducted before a certain o'clock on a certain day in a certain month, it is desired that the transmission shall be conducted after that”. Under such a condition, it is necessary to put the transmission on hold until the time, and in fact, a lot of situations in which transmission cannot be conducted at desired time appear. For example, a lot of extremely difficult situations exist, such as cases where a person boards an airplane or other means of conveyance at time when transmission is desired, and where it falls under a period of a conference, a business talk, a discourse, a lecture, an operation and medical treatment, theatergoing, a concert or the like.

Also, timing of mail transmission is missed, for example in case that, in spite of taking the transmission time into account, and watching and waiting due to such circumstances, it is lost due to the lapse of time. Due to such character mail, a situation in which a significant loss is introduced is expected for use such as home-banking, security exchange, a ticket reservation, an auction and other application reception, which is subject to time restriction.

A function for starting and executing exchange of communications at such planed time really exists in a fixed device for communication, and also, in a desktop computer or the like, various kinds of programs exist. However, in a mobile information terminal, there is nothing that sufficiently satisfies us.

With regard to reception from a distant place, it is possible to utilize a service for transferring the contents being received by a fixed terminal to a mobile information terminal or other reception device, and receive them at an arbitrary place. For example, in JP-A-130424/1997, an electronic mail transfer system is disclosed, in which during a movement a transfer demand signal is transmitted from a mobile type wireless communication terminal via a wireless data communication network, and a transfer of mail that has arrived at a mail communication terminal is received. However, this is focused on only a transfer of the arrival mail and does not at all contribute to the handling of dispatched mail.

### SUMMARY OF THE INVENTION

The present invention is made to solve the above-mentioned problems.

For removing inconvenience in the above-mentioned prior art, a task of the present invention is to provide a mobile information terminal apparatus with a character mail transmission function, which is capable of executing character mail transmission in accordance with mail transmission time that can be arbitrarily set by a user himself regardless of mail generation time in transmission of character mail from a mobile information terminal. In addition, a term “character mail” used in the present invention includes E-mail, short mail and P-mail, and further, a kind of mail having a similar function even though it has different names.

The task of the present invention is solved by a mobile information terminal apparatus with a character mail transmission function, comprising mail generating means for generating character mail, transmission time setting means for setting transmission execution time of the generated character mail, and mail transmitting means for transmitting the character mail at the set time.

The task of the present invention is solved by a mobile information terminal apparatus with a character mail transmission function, in which character mail generation time and character mail transmission execution time are separable, and character mail transmission can be executed at desired time.

Further, the task of the present invention is advantageously solved by a mobile information terminal apparatus with a character mail transmission function, in which it can be selected to set in advance the transmission execution time when character mail is transmitted or to set it after completion of mail generation.

Also, the task of the present invention is further advantageously solved by a mobile terminal apparatus with a character mail function, including an antenna for transmitting and receiving an arrival and departure number and required information to and from a base station, a wireless section for conducting transmission and reception of wireless, a base-band section for coding a data transmitted and received by the wireless section or for decoding the coded data, a central processing section which operates in accordance with program control, a keyboard for conducting display indication and an input or the like of a telephone directory, a display section for displaying received mail and information of a menu or the like, and a transmission information management area for managing transmission time information in mail transmission, and said central processing section comprising mail generating means, transmission execution time setting means, and mail transmitting means.

In accordance with the mobile information terminal apparatus with a character mail transmission function, which is related to the present invention, it becomes possible to take account of convenience of a user himself and internal or external factors and so on of a receiver, and in addition, to set dispatch and/or reception scheduled time and conduct dispatch. A user can prepare required mail before reaching a situation in which use of a mobile information terminal is restricted, such as boarding to means of conveyance, a conference, a business talk, a lecture, medical treatment, and participation in or watching or the like of a competitive sport, and can automatically transmit the said mail after preset time is reached. This is similar to a case where a plan of an act of a receiver is previously understood, and transmission is conducted after time when reception becomes possible is estimated.

In this manner, it becomes possible to taking account of circumstances of a dispatcher and receiver, and in addition, to generate and dispatch character mail, and convenience of the mobile information terminal apparatus with the character mail transmission function can be significantly improved.

### BRIEF DESCRIPTION OF THE DRAWING

This and other objects, features and advantages of the present invention will become more apparent upon a reading of the following detailed description and drawings, in which:

FIG. 1 is a block diagram showing a basic arrangement example of a mobile information terminal apparatus with a character mail function, which is related to the present invention;

FIG. 2 is a flow diagram showing a basic operation in the first embodiment of the mobile information terminal apparatus with the character mail function, which is related to the present invention;

FIG. 3 is a flow diagram showing a time setting operation in the mobile information terminal apparatus with the character mail function, which is related to the present invention;

FIG. 4A, 4B and 4C are display examples when time is set in the mobile information terminal apparatus with the character mail function, which is related to the present invention;

FIG. 5 is a flow diagram showing an operation in the second embodiment of the mobile information terminal apparatus with the character mail function, which is related to the present invention.

FIG. 6 is a flow diagram showing an operation in the third embodiment of the mobile information terminal apparatus with the character mail function, which is related to the present invention.

FIG. 7A and FIG. 7B are display examples when time is set in the third embodiment of the mobile information terminal apparatus with the character mail function, which is related to the present invention;

FIG. 8 is a flow diagram showing an operation in the fourth embodiment of the mobile information terminal apparatus with the character mail function, which is related to the present invention;

FIG. 9A and FIG. 9B are display examples when time is set for every transmission destination in the fourth embodiment of the mobile information terminal apparatus with the character mail function, which is related to the present invention.

### DESCRIPTION OF THE EMBODIMENTS

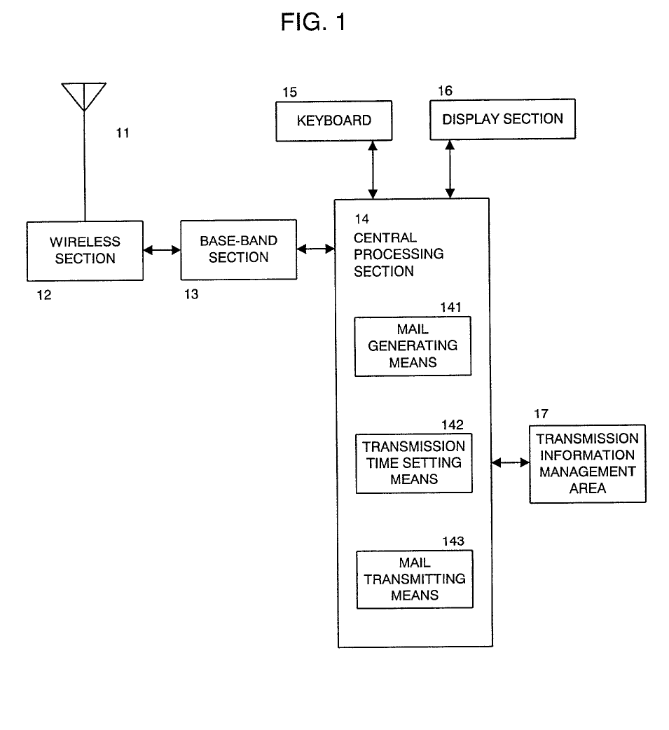

A basic arrangement of a mobile information terminal apparatus with a character mail transmission function, which is related to the present invention, will be explained referring to FIG. 1. It includes an antenna 11 for transmitting and receiving radio waves containing an arrival and departure number and a kind of required information to and from a base station, a wireless section 12 for conducting transmission and reception of wireless, a base-band section 13 for coding a data transmitted and received by the wireless section 12 and decoding the coded data, a central processing section 14 which operates in accordance with program control, a keyboard 15 for conducting an input of display indication of a telephone directory and a numeral and character or the like, a display section 16 for displaying received mail and information of a menu or the like, and a transmission information management area 17 for managing transmission time information in mail transmission. Also, the abovedescribed central processing section 14 comprises mail generating means 141, transmission time setting means 142, and mail transmitting means 143.

The mail generating means 141 receives the input of the keyboard 15 from a user, and conducts generation of mail. After the mail is generated, in the transmission time setting means 142 the user conducts setting of time when the mail is transmitted. And, in the mail transmitting means 143, after the selected time, mail transmission is conducted through the base-band section 13.

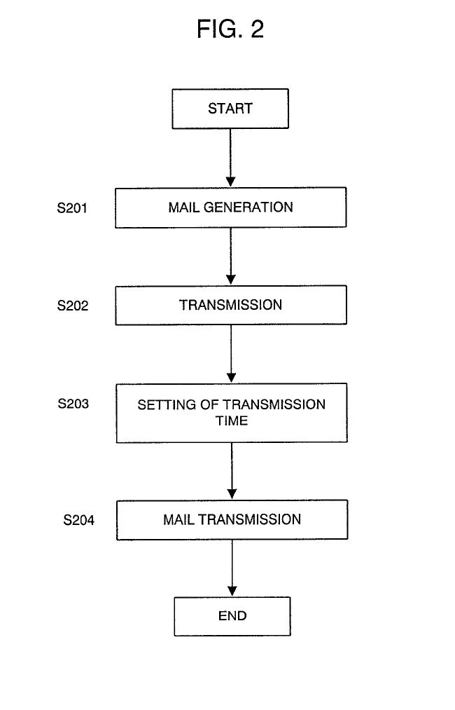

An operation of an embodiment of the mobile terminal apparatus of the character mail function, which has such an arrangement and which is related to the present invention, will be explained. Referring to a block diagram of FIG. 1 and a flow diagram of FIG. 2, a processing flow of the central processing section 14 between the character mail generation and the mail transmission is as follows: First, using the mail generating means 141, character mail to be transmitted is generated (STEP S201), and after the generation of the character mail is completed, a transmission button is operated (STEP S202). By means of this operation, with regard to actual transmission time of the generated mail, using the transmission time setting means 142, the setting of desired transmission execution time is conducted (STEP S203). Using the mail transmitting means 143, the generated mail is transmitted at the selected time (STEP S204).

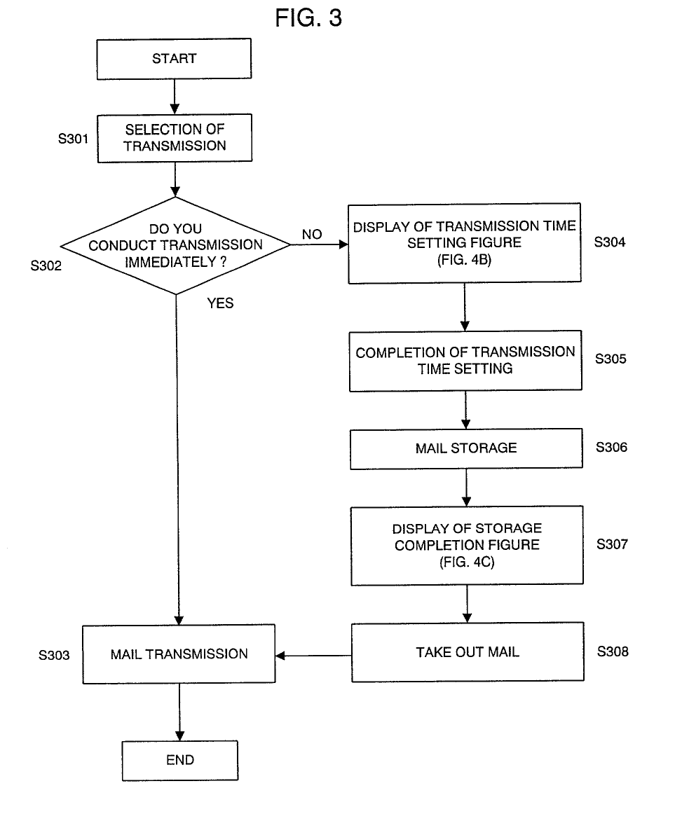

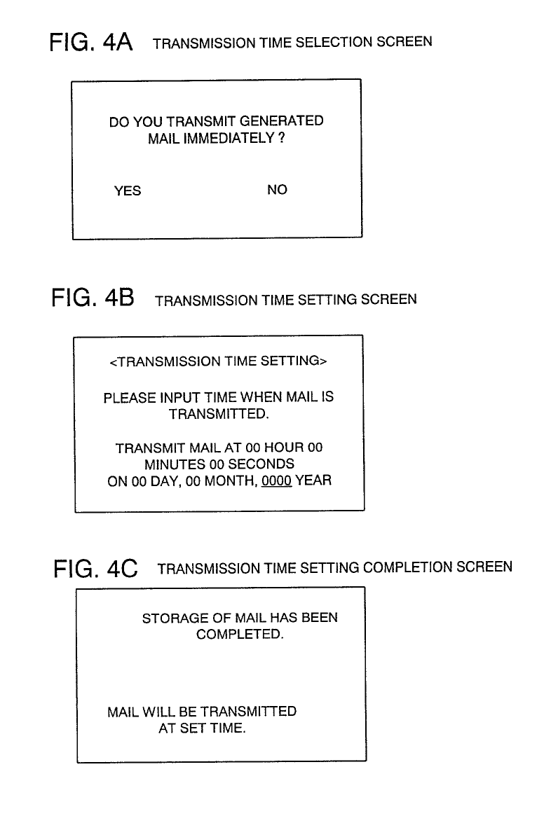

Next, referring to a flow diagram of FIG. 3, and FIG. 4 showing a display example of the display section 16, a flow of transmission time setting will be explained. First, after the completion of the mail generation, a transmission button is operated, and a transmission operation is selected (STEP S301). By means of the transmission selection, a selection screen like FIG. 4A is displayed (STEP S302). In case that immediate transmission without a time delay is desired (STEP S302: Yes), the transmission is immediately executed by the mail transmitting means 143 in accordance with selection of “Yes” (STEP S303).

In case that the specification of transmission time is desired (STEP S302: No), a transmission time setting screen like FIG. 4B is displayed in accordance with the selection of “No” (STEP S304). On this transmission time setting screen, transmission execution time is set (STEP S305), and the transmission time setting means stores the generated mail in the transmission information management area 17 (STEP S306). At this time, a storage completion screen like FIG. 4C is displayed (STEP S307), and the flow returns to a usual waiting screen.

When the set time is reached, the transmission time setting means takes out the stored character mail from the transmission information management area 17 (STEP S308), and transmission is immediately executed by the mail transmitting means 143 (STEP S303), and the flow returns to the usual waiting screen.

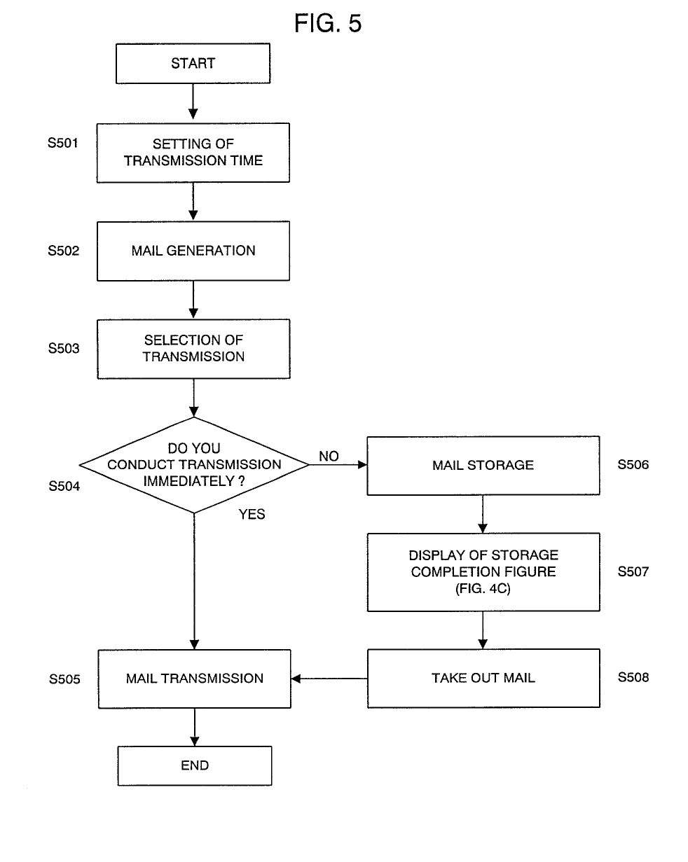

As another embodiment of the present invention, a processing flow of the central processing section 14 between the mail generation and the mail transmission in case that transmission time is set in advance will be explained referring to FIG. 1, FIG. 4 and FIG. 5.

First, using the transmission time setting means 142, a screen like FIG. 4B is opened, and transmission execution time of mail is set in advance (STEP S501). After the transmission time is set, using the mail generating means 141, character mail to be transmitted is generated (STEP S502). After the mail generation is completed and when transmission is selected (STEP S503), by means of the transmission selection, a selection screen like FIG. 4A is displayed (STEP S504).

In case that “Yes” is selected on this screen (STEP S504: Yes), transmission is immediately conducted by the mail transmitting means 143 (STEP S505). In case that transmission is conducted at preset time, “No” is selected (STEP S504: No), and the transmission time setting means 142 stores the generated mail in the transmission information management area 17 (STEP S506). At this time, a storage completion screen like FIG. 4C is displayed (STEP S507) and the flow returns to a usual waiting screen. When previously set time is reached, the transmission time setting means 142 takes out the generated mail from the transmission information management area 17 (STEP S508), and transmission is immediately conducted by the mail transmitting means 143 (STEP S505), and the flow returns to the usual waiting screen.

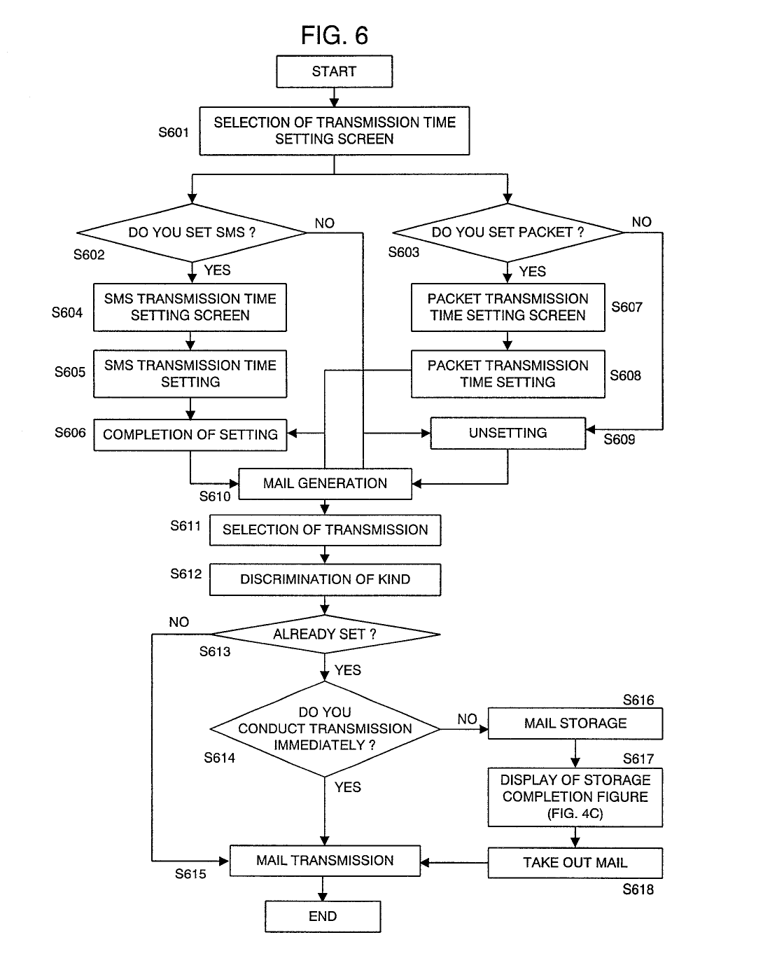

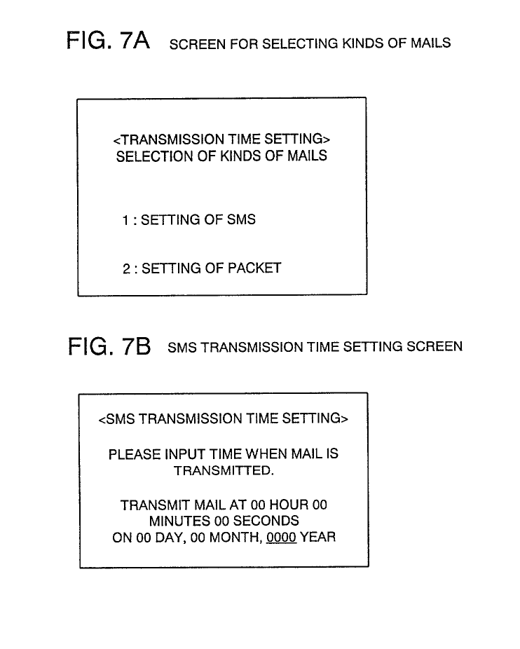

As further other embodiment of the present invention, a processing flow of the central processing section 14 between the mail generation and the mail transmission in case that transmission time is set in advance for every kind of mail will be explained referring to FIG. 1, FIG. 4, FIG. 6 and FIG. 7.

For a kind of mails, a short mail service (referred to as “SMS”, hereinafter) and a packet will be explained as an example. When a transmission time setting screen is opened by using the transmission time setting means 142 (STEP S601), a selection screen like FIG. 7A for setting the SMS (STEP S602) or setting the packet (STEP S603) appears. In case that “1” is selected on this screen and the SMS is selected (STEP S602: Yes), an SMS transmission time setting screen like FIG. 7B is opened (STEP S604), and SMS transmission time is set (STEP S605), and the setting is completed (STEP S606). Here, in case that the SMS transmission time is not set (STEP S602: No), the setting screen ends (STEP S609).

In case that “2” is selected on the transmission time setting screen of FIG. 7A and the packet is selected (STEP S603: Yes), a packet transmission time setting screen like FIG. 7B is opened (STEP S607), and packet transmission time is set (STEP S608), and the setting is completed (STEP S606). In case that the packet transmission time is not set (STEP S603: No), the setting screen ends (STEP S609). After the transmission time is set, using the mail generating means 141, mail to be transmitted is generated (STEP S610). After the mail generation is completed and when transmission is selected (STEP S611), the kinds of mails are discriminated (STEP S612), and in case that the transmission time is already set (STEP S613: Yes), a selection screen like FIG. 4A is displayed (STEP S614).

In case that “Yes” is selected for immediate transmission (STEP S614: Yes), or in case that the transmission time is unset (STEP S613), transmission is immediately conducted by the mail transmitting means 143 (STEP S615). In case that transmission is conducted at preset time (STEP S614: No), the transmission time setting means 142 stores the generated mail in the transmission information management area 17 (STEP S616). At this time, a storage completion screen like FIG. 4C is displayed (STEP S617) and the flow returns to a usual waiting screen. And, when the set time is reached, the transmission time setting means 142 takes out the stored mail from the transmission information management area 17 (STEP S618), and transmission is immediately conducted by the mail transmitting means 143 (STEP S615), and the flow returns to the usual waiting screen.

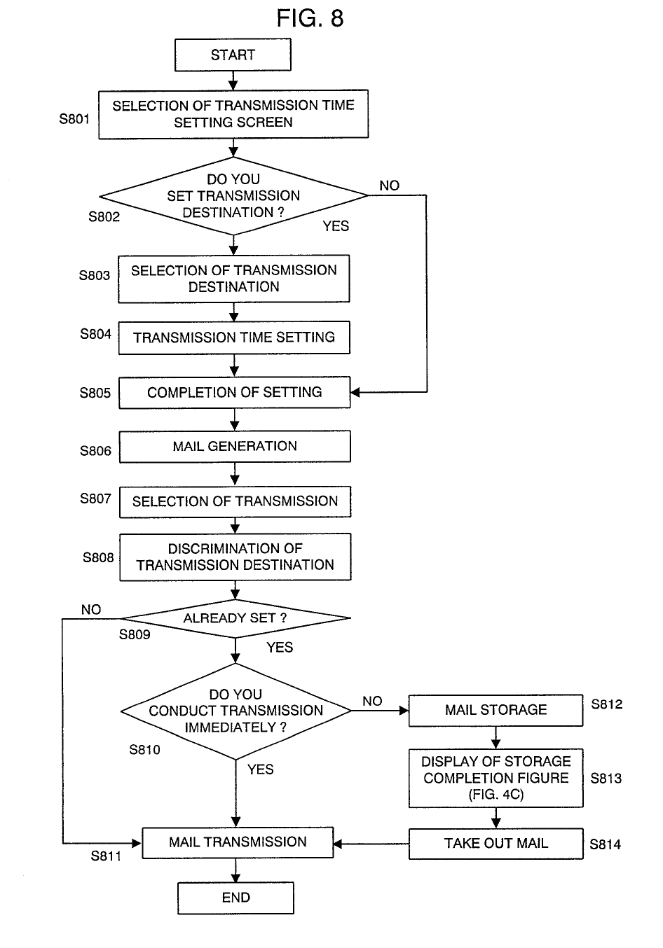

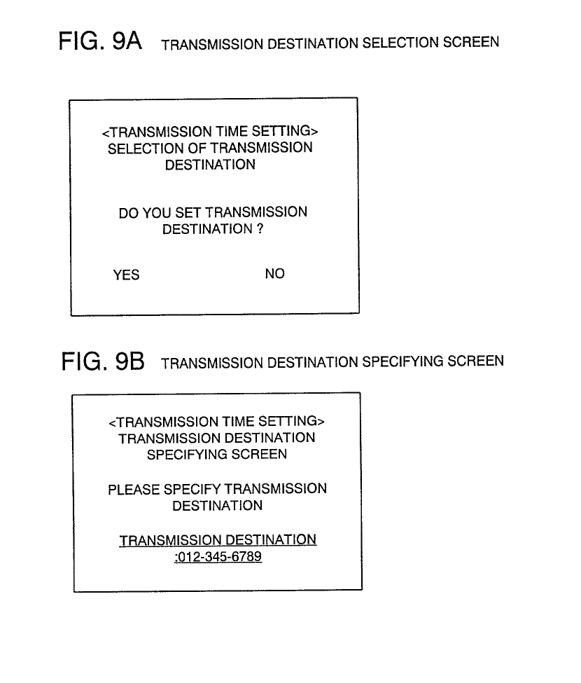

As further other embodiment of the present invention, a processing flow of the central processing section 14 between the mail generation and the mail transmission in case that transmission execution time is set in advance for every transmission destination of mail will be explained using FIG. 1, FIG. 4, FIG. 8 and FIG. 9.

When a transmission time setting screen is opened by using the transmission time setting means 142 (STEP S801), a selection screen like FIG. 9A for selecting whether or not transmission destination is set (STEP S802) appears. In case that transmission destination setting is selected by means of “Yes” on this screen (STEP S802: Yes), a transmission destination specifying screen like FIG. 9B is opened (STEP S803), and accordingly, transmission execution time is set (STEP S804), and the setting is completed (STEP S805). In case that the transmission time for every transmission destination is not set (STEP S802: No), the setting screen ends (STEP S805).

After the transmission execution time is set, using the mail generating means 141, mail to be transmitted is generated (STEP S806). After the mail generation is completed and when transmission is selected (STEP S807), the transmission destinations are discriminated (STEP S808), and in case that the transmission time is already set (STEP S809: Yes), a selection screen like FIG. 4A is displayed (STEP S810). In case that “Yes” is selected for immediate transmission (STEP S810: Yes), or in case that the transmission time for the said mail transmission destination is unset (STEP S809: No), transmission is immediately conducted by the mail transmitting means 143 (STEP S811). In case that transmission is conducted at preset time (STEP S810: No), the transmission time setting means 142 stores the generated mail in the transmission information management area 17 (STEP S812).

At this time, a storage completion screen like FIG. 4C is displayed (STEP S813), and the flow returns to a usual waiting screen. When the set time is reached, the transmission time setting means 142 takes out the generated mail from the transmission information management area 17 (STEP S814), and transmission is immediately conducted by the mail transmitting means 143 (STEP S811), and the flow returns to the usual waiting screen.

In accordance with the mobile information terminal apparatus with the character mail, which is related to the present invention, the generation time and the transmission execution time of character mail can be considered separately, and it is possible to execute the transmission of the character mail at desired time, which was generated in advance. In case that specific selection is not conducted, the mail is transmitted immediately after it is generated. In case that transmission time is set, the selection of transmission execution time can be any of the setting after the mail generation, the setting in advance before the mail generation, and further, the setting in advance for every destination, and when arbitrary set time is reached, the transmission is executed. Accordingly, it becomes possible to add an additional value to the mobile information terminal apparatus, and to provide the mobile information terminal apparatus, convenience of which is improved.

What is claimed is:

1. A mobile information terminal apparatus with a character mail transmission function, characterized in that the apparatus comprises mail generating means for generating character mail, transmission time setting means for setting transmission execution time of the generated character mail, and mail transmitting means for transmitting the character mail at the set time.

2. A mobile information terminal apparatus with a character mail transmission function recited in claim 1, characterized in that character mail generation time and character mail transmission execution time are separable, and character mail transmission can be executed at desired time.

3. A mobile information terminal apparatus with a character mail transmission function recited in claim 2, characterized in that the transmission execution time when character mail is transmitted can be set before mail generation.

4. A mobile information terminal apparatus with a character mail transmission function recited in claim 2, characterized in that the transmission execution time when character mail is transmitted can be set after completion of mail generation.

5. A mobile information terminal apparatus with a character mail transmission function recited in claim 2, characterized in that the transmission execution time when character mail is transmitted can be set in advance for every transmission destination.

6. A mobile terminal apparatus with a character mail function, characterized in that the apparatus includes an antenna for transmitting and receiving an arrival and departure number and required information to and from a base station, a wireless section for conducting transmission and reception of wireless, a base-band section for coding a data transmitted and received by said wireless section and for further decoding the coded data, a central processing section which operates in accordance with program control, a keyboard for conducting an input of display indication of a telephone directory and a numeral and character or the like, a display section for displaying received mail and information of a menu or the like, and a transmission information management area for managing transmission time information in mail transmission, and said central processing section comprises mail generating means, transmission execution time setting means, and mail transmitting means.

7. A mobile information terminal apparatus with a character mail transmission function recited in claim 6, characterized in that character mail generation time and character mail transmission execution time are separable, and character mail transmission can be executed at desired time.

8. A mobile information terminal apparatus with a character mail transmission function recited in claim 7, characterized in that the transmission execution time when character mail is transmitted can be set before mail generation.

9. A mobile information terminal apparatus with a character mail transmission function recited in claim 7, characterized in that the transmission execution time when character mail is transmitted can be set after completion of mail generation.

10. A mobile information terminal apparatus with a character mail transmission function recited in claim 7, characterized in that the transmission execution time when character mail is transmitted can be set in advance for every transmission destination.

11. A character mail transmission method for a mobile information terminal apparatus comprising the steps of:
generating character mail, setting transmission execution time of said generated character mail, and transmitting the character mail at the set time.

12. A character mail transmission method recited in claim 11, characterized in that the transmission execution time when character mail is transmitted can be set before mail generation.

13. A character mail transmission method recited in claim 11, characterized in that the transmission execution time when character mail is transmitted can be set after completion of mail generation.

14. A character mail transmission method recited in claim 11, characterized in that the transmission execution time when character mail is transmitted can be set in advance for every transmission destination.
